(19) United States
(12) Patent Application Publication
(10) Pub. No.: US 2013/0024522 A1
(43) Pub. Date: Jan. 24, 2013

(54) Email to Content Conversion and Publication System for Use in Knowledge Management Solutions

(71) Applicants: Lester S. Pierre, Valley Cottage, NY (US); Michael J. Russo, Staten Island, NY (US); Ridik Shrestha, Woodside, NY (US)

(72) Inventors: Lester S. Pierre, Valley Cottage, NY (US); Michael J. Russo, Staten Island, NY (US); Ridik Shrestha, Woodside, NY (US)

(73) Assignee: Wall Street Network. Inc.

(21) Appl. No.: 13/188,711

(22) Filed: Jul. 22, 2011

(51) Int. Cl. G06F 15/16

(52) U.S. Cl. 709/206

(57) ABSTRACT

An Email to Content Conversion and Publication System for Use in Knowledge Management Solutions giving users of any email system the ability to utilize all features and functionality provided by knowledge management solutions by creating and sending an email using any email system. Users of knowledge management solutions typically create conversations or participations to existing conversations with whatever interface has been provided within the solution. Users of knowledge management solutions create conversations or participations only with the interface provided for creating this content within the knowledge management solution being used. The Email to Content Conversion and Publication System allows users wishing to create content for publication and use in knowledge management solutions to create any content using any email system. Any device capable of sending emails may create content and allow the content to have the appropriate permission settings and publish the content within Knowledge Management Solutions, producing the exact same results as if the user had created the content within knowledge management solutions.

### BACKGROUND OF THE INVENTION

1. Field of the Invention

Organizations use a variety of Knowledge Management (KM) solutions to discover and maintain knowledge and new ideas which are useful, and in most cases, required for an organization's growth and well-being. Wikipedia defines KM as “comprising a range of strategies and practices, including software systems and solutions, used in an organization, to identify, create, represent, distribute, and enable adoption of insights and experiences. Such insights and experiences comprise knowledge, either embodied in individuals or embedded in organizational process or practice.” These KM solutions may take the form of creating conversations and presenting them in a way where all those who would be beneficial to provide insight to that conversation can collaborate and expand on the knowledge contained in the conversations. Users of a KM solution typically create conversations or participations to existing conversations with whatever interface has been provided within the solution. Typically, users of a KM solution may create a conversation or participation only with the interface provided for creating a conversation within the KM solution being used. However, the majority of ideas and knowledge that need to be distributed are thought of on the fly, or outside the workplace, or even in instances where the KM solution is unavailable.

The present invention is an electronic mail (email) to content conversion system which allows users wishing to create or contribute content for publication and use in a KM solution to create the content using any email system. In fact, any device capable of sending emails may create KM content and allow it to have the appropriate permission settings and publish the content within a KM solution, producing the exact same result as if the user had created the content within the KM solution.

Some KM solutions utilize an Enterprise Content Management and Collaboration (ECMO) platform, which in various implementations may be MICROSOFT SHAREPOINT. In various implementations, the KM solution containing the present invention may be WSN INSIGHT. WSN INSIGHT is a social networking tool for knowledge sharing and management among various groups of people, including personnel within an organization. This KM solution connects personnel inside an organization and allows each individual to place thoughts within the KM solution by creating conversations and targeting specific audiences within that organization. Within these types of KM solutions, conversations may be searched, tagged, and published to target audiences and meeting spaces created for a specific organization, making these KM solutions permissive based. Target audiences are the specific individuals the conversations are directed towards and meeting spaces are groups of individuals, which may be arranged by departments within an organization. Other users may then start their own conversations around these thoughts, or comment on other created conversations as feedback, rate the conversation or simply view the conversations that are directed towards the users, as users may only see the conversations they have been targeted for. When creating conversations; users may create tags, upload attachments from external repositories, provide related internet content, and create a target audience or select meeting spaces in which to publish the created conversation.

The present invention allows the user of a KM solution to send an email using an email address which is associated with an email-enabled document library. Email-enabled document libraries are one feature that the ECMC platform provides. Once a document library receives an email, the email to content conversion system is activated allowing the present invention to create content for placement in the KM solution and providing all the benefits that a KM solution has to offer via email systems.

### SUMMARY OF THE PRESENT INVENTION

The present invention relates generally to creating content within knowledge management solutions such as social networking applications for knowledge sharing and management, and more specifically to an email to conversation or participation conversion system for allowing the creation of content for a KM solution using an email system providing a solution whereby the user of such may utilize the features of a KM solution by creating an email without the need for actual use of the KM solution.

A primary object of the present invention is to provide an email to content conversion system for KM solutions where a user has the ability to start a conversation for a KM solution in an email.

Another object of the present invention is to provide an email to content conversion system for KM solutions where the user has the ability to participate in an existing, conversation of a KM solution using an email system.

Yet another object of the present invention is to provide an email to content conversion system where users outside of an organization can start a conversation for a KM solution using an email which is part of an external domain.

Still yet another object of the present invention is to provide an email to content conversion system for KM solutions where users outside of an organization have the ability to participate in existing conversations of a KM solution using an email which is part of an external domain.

Another object of the present invention is to provide an email to content conversion system for KM solutions where the organization has the ability to regulate the amount of KM solutions' features which are available to users utilizing the KM solution through email systems.

The present invention overcomes the shortcomings of the prior art by providing a means for utilizing a KM solution without direct access to the KM solution. Nowhere in the prior art exists an email to content conversion system having the ability to allow a user to utilize all the benefits of a KM solution using an email. Each user has the ability to create an email by sending the email to specific email addresses associated with the KM solution, broken down by target audience and meeting space, to either create a new conversation containing all the portions of a KM solution conversation, participate in an existing conversation or contribute any type of content. The present invention gives the user the ability to compile their knowledge and ideas and provide insights to others' knowledge and ideas on the go from any location, even when the KM solution is not available.

The foregoing and other object and advantages will appear from the description to follow. In the description, reference is made to the accompanying drawings, which forms a pert hereof, and in which the invention may be practiced. These embodiments will be described in sufficient detail to enable those skilled in the art to practice the invention, and it is to be understood that other embodiments may be utilized and that structural changes may be made without departing from the scope of the present invention. In the accompanying drawings, like reference characters designate the same or similar parts through the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now he described, by way of example, with reference to the accompanying drawings in which:

FIG. 1 is a flow diagram illustrating one example of the email to content conversion process;

FIG. 2 is a flow diagram illustrating one example of how KM solutions and created document libraries are configured to correspond to each other;

FIG. 3 is a flow diagram illustrating one example of how content may be converted from an email for a KM solution;

FIG. 4 is a flow diagram illustrating one example of the process of how a conversation is created from an email;

FIG. 5 is a flow diagram illustrating one example of the process of how a participation to an existing conversation is created from an email; and

FIG. 6 is a flow diagram illustrating one example of the process of converting email parts to content parts.

### DETAILED DESCRIPTION OF THE DRAWING FIGURES

The following discussion describes in detail one embodiment of the invention (and several variations of that embodiment). This discussion should not be construed, however, as limiting the invention to those particular embodiments; practitioners skilled in the art will recognize numerous other embodiments as well. For definitions of the complete scope of the invention, the reader is directed to the appended claims.

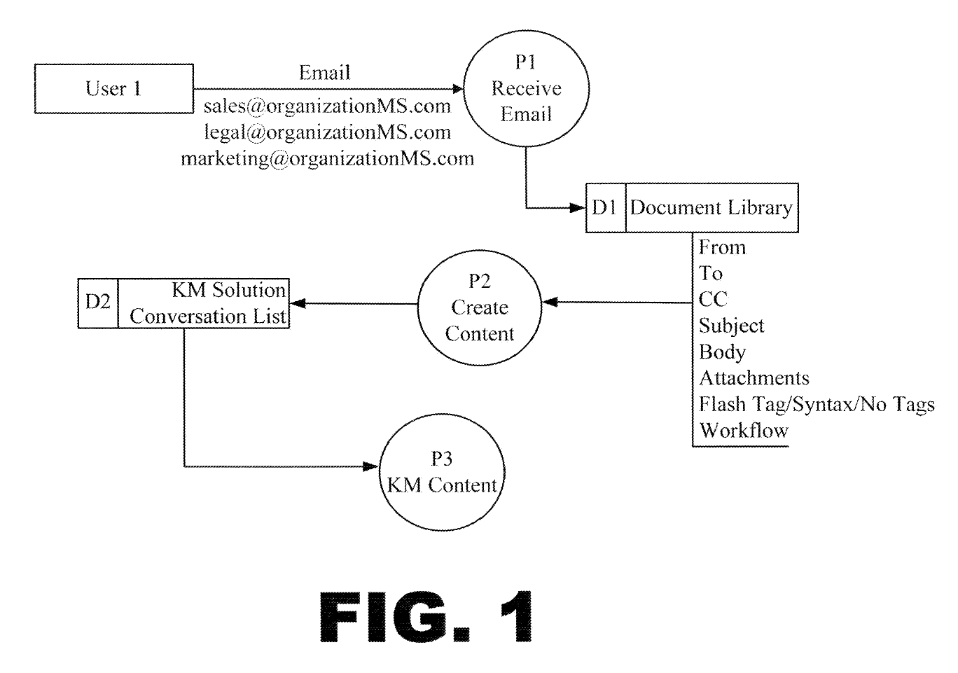

FIG. 1 is a flow diagram illustrating one example of the email to content conversion process. A user of a KM solution composes an email sending it to email address(es) configured for the organization. Each meeting space, usually based on the various departments within an organization, has its own email address. In this example, the meetings space emails which are shown are Sales, Legal, and Marketing. When a user creates an email using the shown email addresses, that user desires to publish his or her content to the Sales, Legal, and Marketing meeting spaces. Once the email is sent, the email system being used receives the email and places the email in a Document Library. Each meeting space email address has a pre-configured Document Library associated with it. In various implementations, the Document Library is a document library within an ECMC platform and may be a MICROSOFT SHAREPOINT DOCUMENT LIBRARY. The Document Library then converts the email parts of From, To, CC, Subject, Body, Attachments, Tags, and Workflow into conversation parts, which creates the content for a KM solution. The content is then stored in a KM Solution's Conversation List. This Conversation List displays the conversation in the appropriate meetings spaces and to the appropriate target audience.

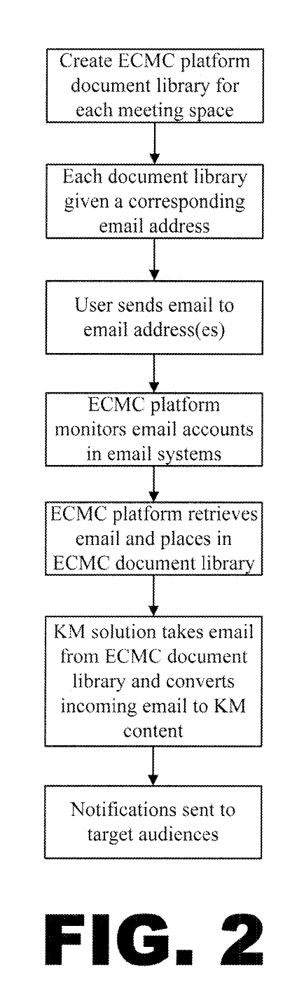

FIG. 2 is a flow diagram illustrating one example of how meeting spaces within KM solutions and ECMC platform document libraries are configured to be associated with each other. First, for each meeting space within an organization, an ECMC platform document library must be created. Each document library and meeting space is given a corresponding email address. A user desiring to convert an email to KM content within a KM solution will create an email using the appropriate email address for the corresponding meeting space the author wishes to publish content to. The email created is sent to the ECMC platform document library corresponding to the meeting space. The document library monitors the exchange for these emails. Each email address is a different account in an email system. There may be multiple email systems incorporated in this process. The ECMC platform monitors the email account in the email systems, then retrieves the email and places it in the document library representing the meeting space. The KM solution then takes the email from the ECMC document library and converts the email to KM content. Once the email is converted into KM content, notifications are sent to the target audiences.

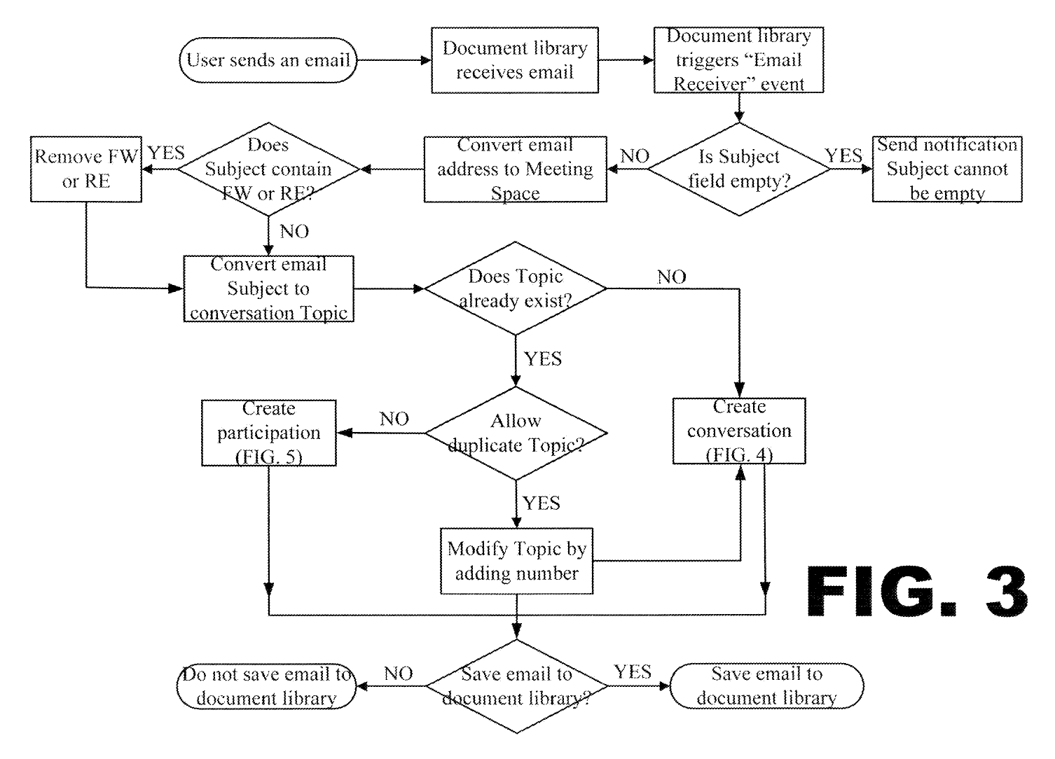

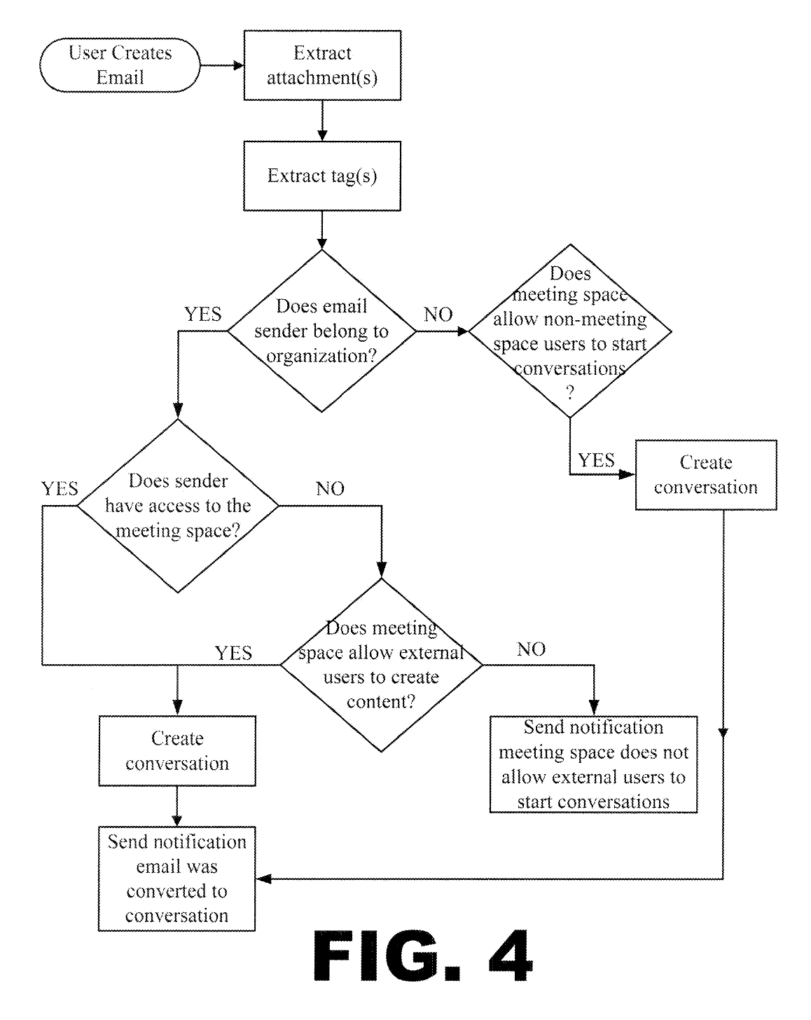

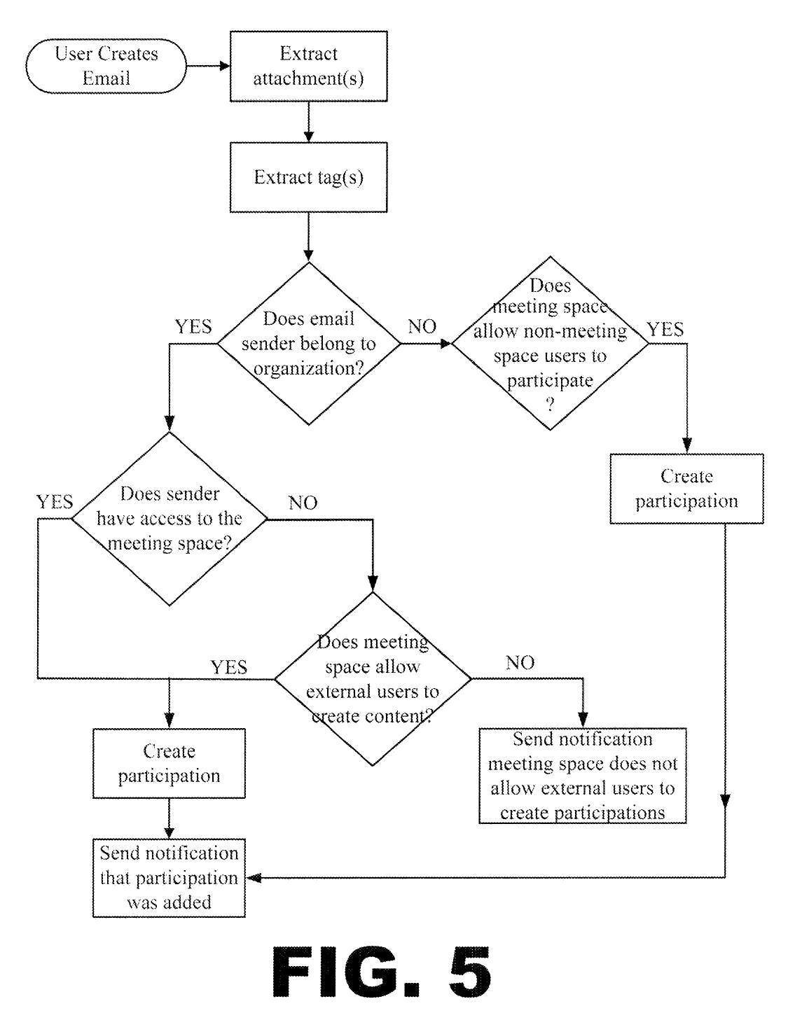

FIG. 3 is a flow diagram illustrating one example of how content may be converted from an email for a KM solution. Once a user sends an email using the appropriate email addresses for the desired meeting spaces, the ECMC platform document library associated with the meeting space receives the email. The document library triggers an “Email Receiver” event which asks the KM solution if the Subject field of the email is empty. If the Subject field of the email is empty, the KM solution sends a notification to the email creator stating that the Subject field cannot be empty. If the Subject field is filled, the email address is converted to the appropriate meeting space(s). The KM solution then asks whether the email created is a reply or a forward by determining if the Subject field contains an RE for reply or FW for forward. If the Subject contains the RE or FW, the RE or FW is trimmed from the Subject. The email Subject is then converted to a conversation Topic. The KM solution next asks whether the Topic already exists for another conversation in the KM solution. If the Topic does not exist, a new conversation is created from converting the email, which will be described in further detail in FIG. 4. If the Topic does exist, the KM solution asks if duplicate Topics are allowed. If duplicate conversation Topics are not allowed, a participation to the conversation with the same Topic is created from converting the email, which will be described in further detail in FIG. 5. If duplicate Topics are allowed, the Topic is modified by the addition of a numerical value to distinguish all topics which are the same. Once either a participation or a conversation is created, the KM solution finally asks whether the email should be saved to the ECMC platform document library. The email is either saved to the document library or not saved to the document library depending on the configuration of this feature by the organization.

FIG. 4 is a flow diagram illustrating one example of the process of how a conversation is created from an email. Once a user sends an email, the ECMC platform extracts all attachments and tags from the email. The KM solution then determines whether the email sender belongs to the organization. If the email sender does not belong to the organization, the KM solution asks whether the meeting space allowed non-organizational users to start conversations. If it is allowed, a new conversation is converted from the email. If the email sender does belong to the organization, the KM solution determines if the sender has access to the meeting space the sender is attempting to send the email to. If the sender does not have access, the KM solution then determines whether the meeting space(s) allow external users to the meeting space to create content. If the user has access or if the meeting space has been configured by the organization to allow external meeting space users to create content, a conversation is converted from the email and a notification of the conversion is sent to the email sender. If the meeting space does not allow external users to the meeting space to create content, then a notification is sent telling the user that the meeting space the sender is attempting to send an email to does not allow external users to the meeting space to create conversations.

FIG. 5 is a flow diagram illustrating one example of the process of how a participation to an existing conversation is created from an email. Once a user sends an email, the ECMC platform extracts all attachments and tags from the email. The KM solution then determines whether the email sender belongs to the organization. If the sender does not belong to the organization, the KM solution asks whether the meeting space that the user is sending an email to allows non-meeting space users to participate in conversations which are a part of that meeting space. If it is allowed, then a participation is created from the email. If the email sender does belong to the organization, the KM solution determines whether the sender has access to the meeting space the sender is attempting to send the email to. If the sender does not have access, the KM solution asks whether the meeting space allows users not having access to the meeting space to create content. If no, then a notification is sent to the sender stating that the meetings space does not allow users without access to the meeting space to create participations. If the sender does have access to the meetings space or if the meeting space does allow users without access to the meeting space to create content, a participation is created from converting the email and a notification is sent to the user that the participation was added to an existing conversation.

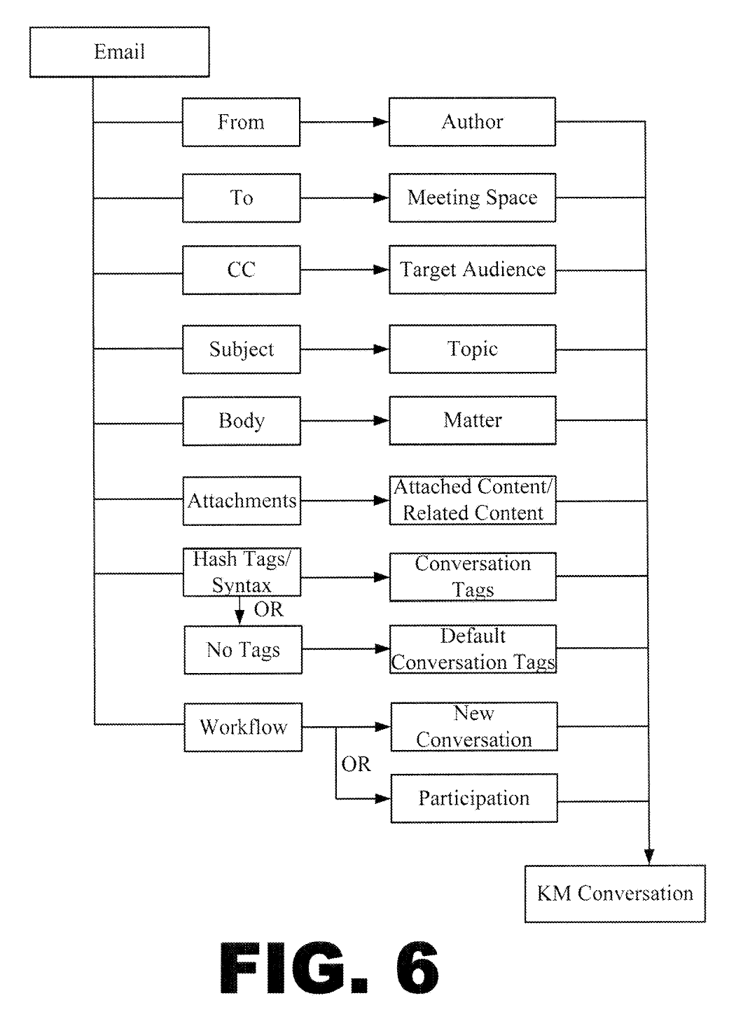

FIG. 6 is a flow diagram illustrating one example of the process of converting email parts to conversation parts. Each part of an email is configured to correspond to each part of a conversation within a KM solution. Shown are the email parts and its corresponding conversation parts. Looking at emails to conversations, From becomes Author, To becomes Meeting Space, Carbon Copy (CC) becomes Target Audience, Subject becomes Topic, Body becomes Matter, Attachments become Attached Content and Related Content, Hash Tags and Syntax become Conversation Tags, Omission of Tags becomes user configured Default Tags, and Workflow is configured to become either a New Conversation or a Participation in an existing conversation.

When the email is sent with the various email parts, two lists are created in the system, a Meeting Space Email list and KM Configuration list. The Meeting Space Email list is where an administrator of the KM solution can map an email to a Meeting Space. The mapping can be, but is not limited to, the email parts and corresponding conversation parts as described above.

The KM Configuration list is where the administrator of the KM solution can configure the parameters for distinguishing between an email that is to be converted into a new conversation or an email that is to be converted to a participation for an already existing email. For email to a new conversation, the KM solution may be configured so that anytime there exists duplicate subjects (titles) for an existing conversation and a new email to conversation, this email will be a new conversation. For email to participation within a conversation, the KM solution may be configured so that anytime there exists duplicate subjects (titles) for an existing conversation and a new email to conversation, this email will be a participation within an existing conversation having the same title.

When a user creating an email uses the email system's reply (RE) or forward (FW) function, a new conversation is created if duplicate titles are allowed. If duplicate titles are not allowed, the email is converted into a participation in an existing conversation, similar to the process described for email conversion discussed above.

What is claimed is new and desired to be protected by Letters Patent and is set forth in the appended claims:

1. An Email to Content Conversion and Publication System for Knowledge Management Solutions comprising a means for creating and publishing content to a knowledge management solution using an email system.

2. An Email to Content Conversion and Publication System for Knowledge Management Solutions wherein said means comprises
a. configuring email addresses for each meetings space of an organization;
b. a means for configuring a document library for association with each meeting space;
c. sending an email using a configured email address;
d. receiving and placing the email by an email system into the appropriate document library;
e. a means for converting email parts into a knowledge management solution's content parts by the document library;
f. storing of the content by the document library into the knowledge management solution's conversation list; and
g. publishing the content by the knowledge management solution's conversation list in the appropriate meeting space.

3. The Email to Content Conversion and Publication System for Knowledge Management Solutions according to claim 2, wherein said means for configuring a document library for association with each meeting space comprises
a. creating a document library for each meeting space of an organization;
b. giving a corresponding email address to each meeting space and each meeting space's document library;
c. creating an email using the appropriate email addresses for the corresponding meetings space a user wishes to publish content to;
d. sending the created email to the document library corresponding to the meeting space; and
e. creating and publishing by the document library the converted content in the meeting space corresponding to the document library.

4. The Email to Content Conversion and Publication System for Knowledge Management Solutions according to claim 2, wherein said means for converting email parts into a knowledge management solution's content parts by the document library comprises creating lists in the knowledge management solution for each meeting space and a knowledge management solution list in the Enterprise Content Management and Collaboration Platform.

5. The Email to Content Conversion and Publication System for Knowledge Management Solutions according to claim 1, further comprising a means for starting a conversation for publication in a knowledge management solution using an email.

6. The Email to Content Conversion and Publication System for Knowledge Management Solutions according to claim 1, further comprising a means for participating in an existing conversation in a knowledge management solution using an email.

7. The Email to Content Conversion and Publication System for Knowledge Management Solutions according to claim 1, further comprising a means for creating and publishing a conversation in a knowledge management solution using an email which is part of an external domain.

8. The Email to Content Conversion and Publication System for Knowledge Management Solutions according to claim 1, further comprising a means for participating in an existing conversation in a knowledge management solution using an email which is part of an external domain.

9. The Email to Content Conversion and Publication System for Knowledge Management Solutions according to claim 1, further comprising a means for regulating the amount of feature of a knowledge management solution which are available through email.

10. The Email to Content Conversion and Publication System for Knowledge Management Solutions according to claim 1, further comprising a means for allowing duplicate titles for creating a new conversation using an email or creating a participation within an existing conversation using an email.

11. The Email to Content Conversion and Publication System for Knowledge Management Solutions according to claim 1, further comprising a means for mapping emails for converting specific email parts to specific conversation parts.
